(19) United States
(12) Patent Application Publication
(10) Pub. No.: US 2008/0300014 A1
(43) Pub. Date: Dec. 4, 2008

(54) METHODS OF OPERATING A SYNERGETIC TANDEM POCKET DEVICE

(75) Inventors: Moshe Raines, Tel-Aviv (IL); Daniel Fuchs, Ramat Gan (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD., KFAR SABA (IL)

(21) Appl. No.: 12/132,667

(22) Filed: Jun. 4, 2008

Related U.S. Application Data
(60) Provisional application No. 60/941,697, filed on Jun. 4, 2007.

(51) Int. Cl. H04M 1/00

(52) U.S. Cl. 455/556.1

(57) ABSTRACT

A method of operating a communications system including a mobile phone and a media playback device is disclosed. When the mobile phone is uncoupled from the media playback device, voice telephony services are provided by the mobile phone using an onboard RF transceiver of the mobile phone. When the media playback device is uncoupled from mobile phone, media playback services are provided by the media playback device using an onboard CODEC and an onboard display screen of the media playback device. When the media playback device and the mobile phone are operatively coupled together to form a tandem device, video telephony services are provided by the tandem device using the RF transceiver of the mobile phone, the CODEC of the media playback device and the display screen of the media playback device. Methods of operating a GPS system including a screenless GPS device and a mobile phone are also disclosed herein.

### CROSS-REFERENCE TO RELATED APPLICATIONS

This patent application claims the benefit of U.S. Provisional Patent Application No. 60/941,697 filed Jun. 4, 2007 by the present inventors.

### FIELD OF THE INVENTION

The present invention relates to portable electronic devices, and in particular to video telephones, media playback devices, mobile phones and GPS devices.

### BACKGROUND AND RELATED ART

Portable, pocket-sized, electronic devices (mobile phones, PDAs, MP3 players, UFDs, remote control key holders) are very well known in the art of consumer products. Typically these portable devices include a power source (for example, an onboard battery), electronic circuitry, user control(s), and indicators.

For convenience of carrying and use, many portable electronic devices are provided as a multifunctional portable integrated system (PIS)—i.e. as a portable system that has at least two different functionalities, integrated into a single package and sharing at least one resource. Thus, it is common to see a PDA that is also a mobile phone, a mobile phone that is also a multimedia player, and so on.

Some of the above mentioned functionalities require the user's full attention when active (such as a mobile phone or PDA). When a multifunctional “integrated” device is used to provide a given functionality, the components of the PIS that are associated with a ‘dormant’ functionality are often a burden. For example, in a PIS that integrates a video game and a mobile phone; a noisy game may be disturbing when the PIS is used as a mobile phone.

There is clearly a trade off between the convenience of the PIS integration and the efficiency of using each functionality. Typically, it is more convenient to carry the PIS in one's pocket than two separate units; however hands-on use may be less convenient for the user.

It would be very desirable to have a multifunctional pocket-sized device that includes multiple ‘constitutive’ units that function both when attached to each other and when physically separated from each other, and which provides different functionalities when the constitutive units are operatively attached and when the constitutive units are detached.

### SUMMARY OF EMBODIMENTS OF THE INVENTION

Various embodiments address these and related issues, examples of which embodiments, including methods and systems, are provided herein.

It is now disclosed for the first time a communications system comprising: a) a mobile phone including an onboard RF transceiver; and b) a media playback device including an onboard CODEC and an onboard display screen, wherein the mobile phone and the media playback are operative such that: i) when the mobile phone is uncoupled from the media playback device, the mobile phone is operative to provide voice telephony services using the onboard RF transceiver; ii) when the media playback device is uncoupled from mobile phone, the media playback device is operative to provide media playback services using the onboard CODEC and the onboard display screen; and iii) when the media playback device and the mobile phone are operatively coupled together to form a tandem device, the tandem device is operative to provide video telephony services using the RF transceiver of the mobile phone, the CODEC of the media playback device and the display screen of the media playback device.

According to some embodiments, i) the mobile phone includes a phone-side port; ii) the media playback device includes a device-side port; and iii) when the mobile phone-side port is mechanically engaged to the device-side port to provide the operative coupling, a majority of a volume of the mobile phone is located within a bounding volume of the media playback device.

According to some embodiments, a product of the two longest dimensions of a bounding box of the media playback device is less than twice a product of the two longest dimensions of a bounding box of the phone.

According to some embodiments, i) the mobile phone includes a phone-side port; ii) the media playback device includes a device-side port; and iii) when the mobile phone-side port is mechanically engaged to the device-side port to provide the operative coupling and to form the tandem device, a volume of a bounding box of the tandem device is less than 70% times a sum of: A) a volume of a bounding box of the mobile phone; and B) a volume of a bounding box of the media playback device.

According to some embodiments, i) the mobile phone includes a phone-side port and a phone keypad; ii) the media playback device includes a device-side port; and iii) mechanical engagement of the phone-side port to the device-side port to form the tandem device is operative to mechanically block user access to the phone keypad of the mobile phone.

According to some embodiments, the media playback device lacks an RF transceiver.

According to some embodiments, i) the media playback device includes at least one user control mechanically integrated into a housing of the media playback device; and ii) the tandem device is operative to provide the video telephony services in accordance with user input received via the user control when the media playback device is coupled to the mobile phone.

According to some embodiments, i) the mobile phone includes an onboard rechargeable battery; and ii) the operative coupling of the mobile phone to the media playback device is operative to commence a recharging operation whereby the onboard rechargeable battery receives electrical power from the media playback device.

According to some embodiments, i) the mobile phone lacks a camera; and ii) the tandem device provides the video telephony services using a camera of the media playback device.

According to some embodiments, a maximum power consumption of the mobile phone is less than 20% of a maximum power consumption of the media playback device.

It is now disclosed for the first time a method of operating communications system including a mobile phone and a media playback device, the method comprising: a) when the mobile phone is uncoupled from the media playback device, providing voice telephony services by the mobile phone using an onboard RF transceiver of the mobile phone; b) when the media playback device is uncoupled from mobile phone, providing media playback services by the media playback device using an onboard CODEC and an onboard display screen of the media playback device; and c) when the media playback device and the mobile phone are operatively coupled together to form a tandem device, providing video telephony services by the tandem device using the RF transceiver of the mobile phone, the CODEC of the media playback device and the display screen of the media playback device.

According to some embodiments, the method further comprises: d) mechanically engaging the mobile phone and the media playback device via respective device ports such that a majority of a volume of the mobile phone is located within a bounding volume of the media playback device.

According to some embodiments, the mechanical engagement is carried out such that a product of the two longest dimensions of a bounding box of the media playback device is less than twice a product of the two longest dimensions of a bounding box of the phone.

According to some embodiments, the method further comprises: d) mechanically engaging the mobile phone and the media playback device via respective device ports to provide the operative coupling and to form the tandem device such that a volume of a bounding box of the tandem device is less than 70% times a sum of a volume of a bounding box of the mobile phone and a volume of a bounding box of the media playback device.

According to some embodiments, the method further comprises: d) mechanically engaging the mobile phone and the media playback device via respective device ports such that the mechanical engaging blocks user access to the phone keypad of the mobile phone.

According to some embodiments, the video telephony services are provided in accordance with user input that is received via a user control of the video playback device at a time when the media playback device is coupled to the mobile phone.

According to some embodiments, the method further comprises: d) in response to an operative coupling between the media playback device and the mobile phone, commencing a recharging operation whereby the onboard rechargeable battery receives electrical power from the media playback device.

It is now disclosed for the first time a GPS system comprising: a) a screenless GPS device including a microphone, an audio speaker and a GPS module; and b) a mobile phone including a screen and a keypad, wherein the mobile phone and the screenless GPS device are operative such that: i) when the mobile phone is uncoupled from the screenless GPS device, the mobile phone is operative to provide voice telephony services using the screen and the keypad; ii) when the screenless GPS device is uncoupled from mobile phone, the screenless GPS device is operative to receive voice commands via the microphone, to generate GPS data in accordance with the received voice commands using the GPS module, and to present the GPS data generated according to the voice commands using the audio speaker; and iii) when the mobile phone and the screenless GPS device are operatively coupled together to form a tandem device, the tandem device is operative to receive typed commands via the keypad of the mobile phone, to generate OPS data in accordance with the received typed commands using the GPS module, and to present on the screen of the mobile phone the GPS data generated according to the typed commands.

It is now disclosed for the first time a method of operating a system including a screenless GPS device and a mobile phone, the method comprising: a) when the mobile phone is uncoupled from the screenless GPS device, providing voice telephony services by the mobile phone using a screen and a keypad of the mobile phone; b) when the screenless GPS device is uncoupled from mobile phone, providing GPS services by i) receiving voice commands via a microphone of the GPS device; ii) generating GPS data in accordance with the received voice commands using a GPS module of the GPS device; and iii) presenting the GPS data generated according to the voice commands using the audio speaker; and c) when the mobile phone and the screenless GPS device are operatively coupled together to form a tandem device, providing GPS services by: i) receiving typed commands via the keypad of the mobile phone; ii) generating GPS data in accordance with the received typed commands using the CPS module of the GPS device, and iii) presenting on the screen of the mobile phone the GPS data generated according to the typed commands.

It is noted that features described above as pertaining to certain embodiments may also be included in other embodiments, unless indicated to the contrary hereinbelow.

### BRIEF DESCRIPTION OF THE DRAWINGS

FIGS. 1A-1D illustrate a coupling of a media playback device to a mobile phone to form a ‘tandem’ videophone device in accordance with some embodiments;

FIG. 2 is a block diagram of an exemplary videophone device including a first unit that functions as a mobile phone when detached and a second unit which functions as a media playback device when detached;

FIGS. 3A-3C illustrate an exemplary packaging of two units to form a tandem device in accordance with some embodiments; and

FIG. 4 is a block diagram of an exemplary system including a screenless GPS device which when coupled to a mobile phone, forms a ‘tandem’ GPS device in accordance with some embodiments.

### DETAILED DESCRIPTION OF EMBODIMENTS

The claims below will be better understood by referring to the present detailed description of example embodiments with reference to the figures. The description, embodiments and figures are not to be taken as limiting the scope of the claims. It should be understood that not every feature of the presently disclosed electronic devices and methods of operating the same is necessary in every implementation. It should also be understood that throughout this disclosure, where a process or method is shown or described, the steps of the method may be performed in any order or simultaneously, unless it is clear from the context that one step depends on another being performed first. As used throughout this application, the word “may” is used in a permissive sense (i.e., meaning “having the potential to”), rather than the mandatory sense (i.e. meaning “must”).

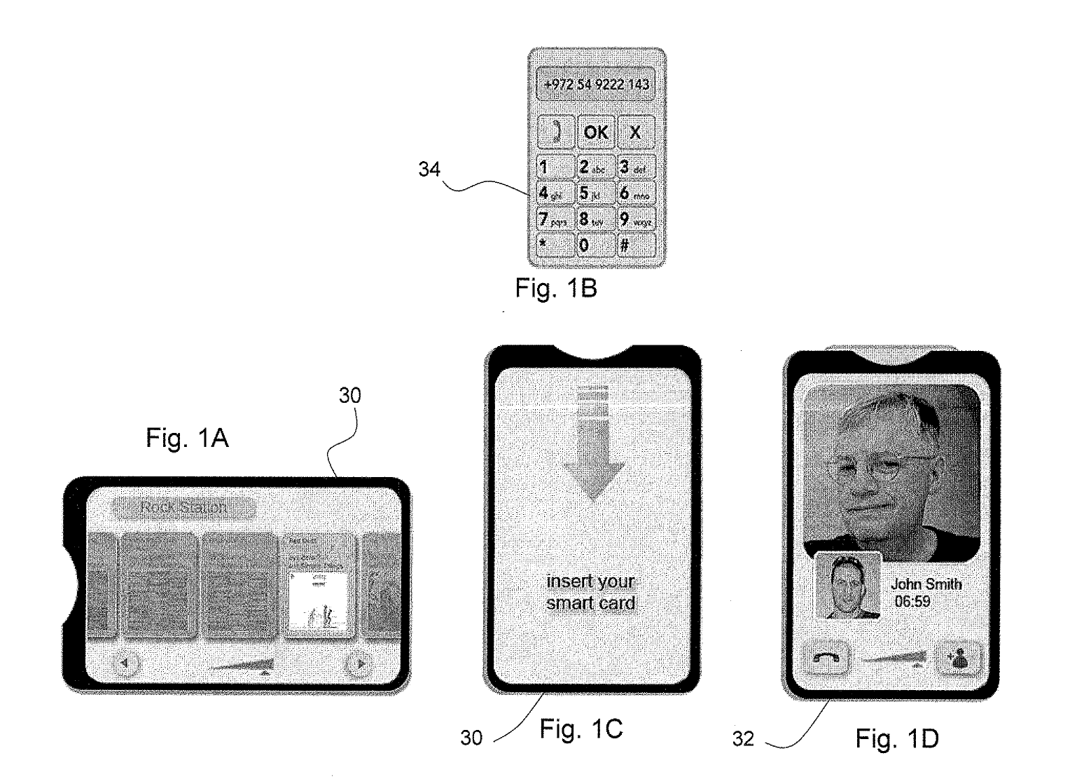

### A Brief Discussion of FIGS. 1A-1D

FIG. 1A is an image of an exemplary media playback device 30 (for example, an MP4 player) for providing media playback services in accordance with some embodiments. The playback device 30 includes an onboard media CODEC for decoding a digital media content, and an onboard screen for displaying a video stream generated by the CODEC.

FIG. 1B is an image of an exemplary mobile telephone 34 for providing voice telephony services in accordance with some embodiments. In the non-limiting example of FIG. 1B, the mobile telephone 34 is a “thin” mobile phone that provides the essential mobile functions such as dialing and receiving voice phone calls.

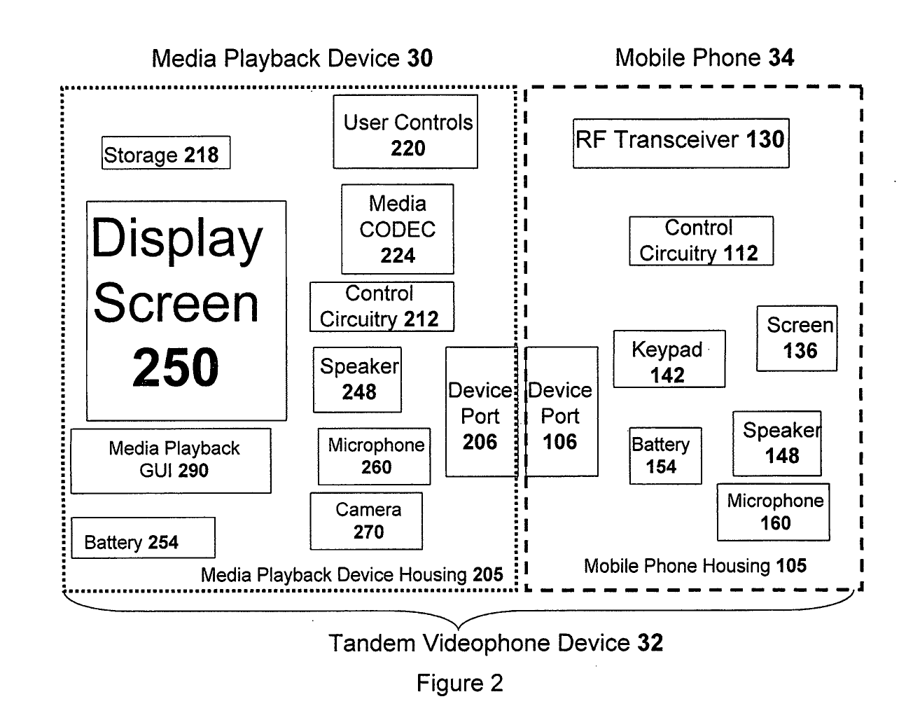

As illustrated in FIGS. 1C-1D, mobile telephone 34 may be operatively coupled with the media playback device 30 to form a “tandem” videophone device 32. The tandem videophone device 32 is operative to provide video telephony services using the RF transceiver of the mobile phone 34, the onboard video decoder of the media playback device 30, and the screen of the media playback device 30. In some embodiments, mobile telephone 34 and the media playback device 30 are coupled to each other via respective device ports—for example, a plug and a socket (not shown in FIGS. 1A-1D—see elements 106 and 206 in FIG. 2) that are mated to each other.

As illustrated in the non-limiting example of FIG. 1C, phone 34 and media playback device 30 may be coupled when the phone is inserted into a ‘slot’ or ‘recess’ of a housing of the media playback device 30. Thus, according to the non-limiting example of FIG. 1C, the “size” of the videophone ‘tandem’ device 32 is on the same order of magnitude as the “size” of both the mobile phone 34 and the media playback device 30. Not wishing to be bound by any particular example, it is noted that this may be useful for providing: (i) the option to use each ‘component’ device of the tandem device separately; and (ii) a ‘streamlined’ tandem device (i.e. which provides the additional videophone functionality that each component device lacks) whose portability is comparable to the portability of each ‘component device’.

Optionally, the phone 34 and the media playback device 30 may be configured to provide one or more of the following ‘streamline packaging’ features when coupled:

A) according to a first “packaging” feature, i) the mobile phone 34 includes a device port (for example, a plug or socket) mechanically integrated with a housing of the mobile phone; ii) the media playback device 30 includes a device port mechanically integrated with a housing of the media playback device 30; and iii) when the mobile phone-side port is mechanically engaged to the device-side port so that the phone 34 is operatively coupled to the media playback device 30, a majority (i.e. at least 50%) of a volume of the mobile phone 34 is located within a bounding volume of the media playback device In some embodiments, the majority is a significant majority of at least 80%. This first packaging feature is illustrated in FIGS. 1C-1D where the mobile phone 34 is inserted into a ‘slot’ or ‘recess’ of media playback device 30;

B) according to a second ‘packaging’ feature, a ‘size’ of the ‘media playback device 30’ is (i) greater than a ‘size’ of the phone 34; and (ii) is, nevertheless, still on the same ‘order of magnitude’ as a ‘size’ of the phone 34. In one embodiment, a product of the two longest dimensions of a bounding box of the media playback device 30 is less than twice a product of the two longest dimensions of a bounding box of the phone 34 (the terms “bounding volume,” “bounding box,” “volume of bounding box” and the like are used interchangeably in this application);

C) according to a third ‘packaging feature,’ i) the mobile phone 34 includes a device port (for example, a plug or socket) mechanically integrated with a housing of the mobile phone; ii) the media playback device 30 includes a device port mechanically integrated with a housing of the media playback device 30; and iii) when the mobile phone-side port is mechanically engaged to the device-side port to provide the operative coupling and to form the tandem device 32, a volume of a bounding box of the tandem device 32 is less than 70% times a sum of (a): a volume of a bounding box of the mobile phone 34; and (b) a volume of a bounding box of the media playback device 30;

D) according to a fourth packaging feature, i) the mobile phone 34 includes a phone-side port and a phone keypad; ii) the media playback device 30 includes a device-side port; and iii) mechanical engagement of the phone-side port to the device-side port to form the tandem device 32 is operative to mechanically block user access to the phone keypad of the mobile phone 34. Thus, as shown in FIG. 1C, the phone keypad of the mobile phone 34 is blocked by media playback device 30 when the playback device 30 and the phone 34 are coupled together.

Not wishing to be bound by any particular example, it is noted that one or more of the aforementioned packaging features may be useful for providing a user experience where: (i) the user may carry around a mobile phone with no need to carry around one or more possibly expensive components related to playback or screening of video content; (ii) when the mobile phone and the media playback device are coupled together, the device provides the additional videophone functionality not provided by uncoupled mobile phone or the uncoupled media playback device; and (iii) the coupled ‘tandem’ videophone device, nevertheless, is relatively ‘compact’.

Each of the aforementioned optional ‘packaging features’ is provided by the devices 30, 32, 34 in FIG. 1C. It is appreciated that in some embodiments, any combination of the aforementioned ‘packaging features’, or none of the features may be provided.

### DEFINITIONS

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

A “CODEC” is a specialized chip or group of chips, or a software program capable of (i) effecting a media playback (i.e. including decoding and/or decompressing) of digital media content to generate a video stream and optionally an audio stream; and/or (ii) encoding and/or compressing a video stream (for example, generated by a video camera) and optionally an audio stream (for example, generated by a microphone).

‘Digital media content’ refers to encoded media content—i.e. audio content and/or encoded video content. Exemplary digital media content includes but is not limited to .mp4 files, mpeg files, divx files, and XviD files.

A “media presentation device” refers to a display screen and/or an audio speaker.

Control circuitry refers to any combination of hardware (for example, including a microprocessor and optionally volatile memory such as RAM or registers), firmware and/or software (for example, computer code which is stored in volatile and/or non-volatile memory and is executable by a microprocessor).

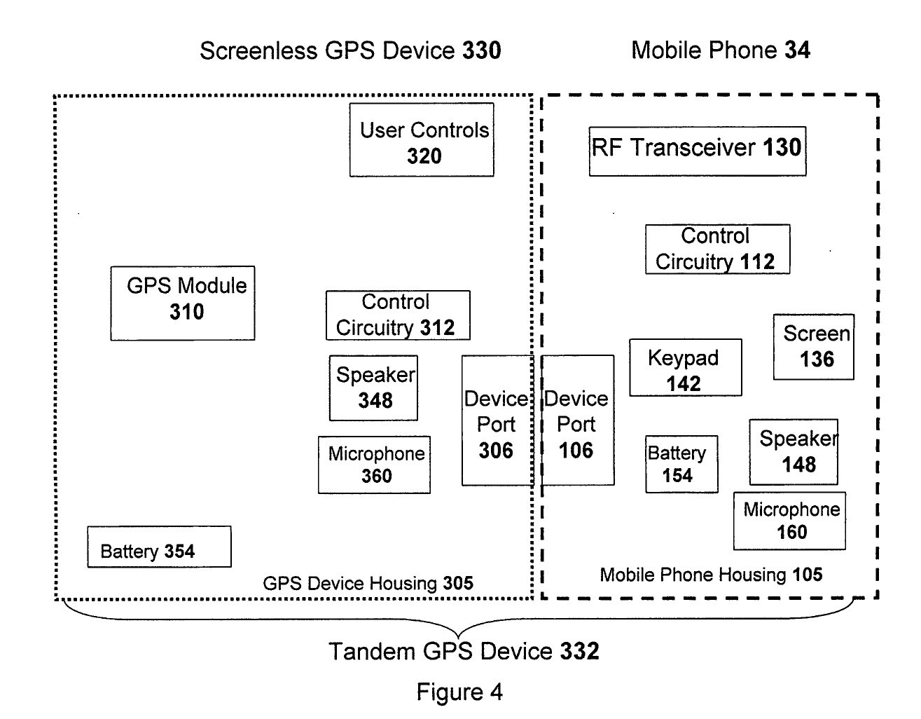

When a component of a device (for example, a component of playback device 30 or a component of mobile phone 34 of FIG. 2 or a component of screenless GPS device 330 of FIG. 4) is described as an “onboard” component, this description refers to a component that is (i) located within a housing of the device; and/or (ii) attached to the inside and/or outside of a housing of the device.

A tandem system or a tandem device refers to a system comprising two independent or stand-alone units, the two units being capable of being physically and operationally coupled and uncoupled, wherein: (i) each unit has an independent function when the units are uncoupled from each other; and (ii) a new ‘additional’ functionality is provided when the units are coupled to each other.

### A Discussion of FIG. 2

FIG. 2 provides a block diagram of an exemplary tandem device/communications system 32 described in FIGS. 1A-1D. As illustrated in FIG. 2, tandem device 32 includes video playback device 30 and mobile phone 34.

When mobile phone 34 is uncoupled from the media playback device 30, mobile phone 34 is operative to provide voice telephony services. Mobile phone 34 includes microphone 160, RF transceiver 130, control circuitry 112, speaker 148, screen 136, keypad 142, battery 154, device port 106 and mobile phone housing 105. Any component(s) of mobile phone 34 may be fixed within and/or attached to and/or mechanically integrated with media playback device housing 205.

In one non-limiting example, mobile phone 34 is a cellular phone, for example, a CDMA and/or GSM cellular phone. Alternatively or additionally, mobile phone 34 is a Voice over Internet Protocol (VoIP) device, for example, a VoIP device operative to communicate via a Wireless Local Area Networks (WLANs) network. It is appreciated that mobile phone 34 may be also operative to provide voice telephony services when coupled to media playback device 30.

As illustrated in the non-limiting example of FIG. 2, media playback device 30 includes display screen 250, a software and/or hardware media CODEC 224, control circuitry 212, speaker 248, user controls 220 (for example, one or more keys or buttons, or a touch screen), microphone 260, camera 270, media playback device housing 205, device port 206 and battery 254. Any component(s) of media playback device 30 may be fixed within and/or attached to and/or mechanically integrated with media playback device housing 205.

When media playback device 30 is uncoupled from mobile phone 34, media playback device 30 is operative to provide media playback services by: (i) effecting a playback of digital media content stored in onboard storage 218 to generate a video stream (and optionally audio stream) using media CODEC 224; (ii) present the generated video stream on onboard display screen 250; and (iii) optionally present the generated audio stream on onboard speaker 248. The illustrated media playback device 30 also includes media playback GUI 290 (for example, code which is executed by control circuitry 212) which may be operated using user controls 220. Media playback GUI 290 may be used for selecting a media content item for playback, for starting/stopping/pausing playback or for any other purpose related to playback digital content item(s).

In one non-limiting example, media playback device 30 lacks an RF transceiver. In another non-limiting example, media playback device 30 includes a ‘local’ RF transceiver (not shown) for communicating via a Wireless Local Area Networks (WLANs) network, while RF Transceiver 130 of mobile phone 34 is configured to communicate via a cellular network.

When media playback device 30 is coupled to mobile phone 34 via respective device ports 106, 206 to form a videophone ‘tandem’ device 32, the videophone device 32 may provide video telephony services using (i) CODEC 224 of the media device; (ii) RI transceiver 130 of the mobile phone 34; and (iii) display screen 250 of the media playback device 30. In some embodiments, the video telephony services are provided using camera 270 of the media playback device 30 to capture a set of video images and using microphone 260 of the media playback device for recording sound. Alternatively or additionally, a camera of mobile phone 34 (not shown) and/or microphone 160 of mobile phone 34 may be used.

In some embodiments, control circuitry 112 of mobile phone includes a call routing module (not shown) and/or a protocol module (not shown) for routing a call via an IP or cellular network and/or transforming voice and/or video signals into signals recognizable by an IP or cellular network. In one example, control circuitry 112 may provide some or all of this functionality both (i) for the ‘voice calls’ handled by mobile phone 34 when mobile phone 34 is uncoupled from video playback device 30; and (ii) ‘videophone calls’ handled by the tandem videophone device 32.

In yet another example, control circuitry 212 of the video playback device 30 provides some or all of this functionality for the tandem videophone device 32.

### Responses to Detected Couplings and Decouplings

In different embodiments, one or more of the following features may be provided in response to a detected coupling between the video playback device 30 and the mobile phone 34:
a) in response to the detected coupling, a ‘videophone interface’ may be presented on display screen 250 of the video playback device, providing an indication that video telephone services are now available to the user. The ‘videophone interface’ may include one or more of: (i) a dialing interface for dialing a telephone number or providing any other ‘destination calling party’ identifier; (ii) a list of one or more recent ‘destination’ with whom the user has conversed using either videophone 32 and/or the mobile phone 34 in ‘detached mode’; (iii) any other information related to historical usage of mobile phone 34 and/or the videophone ‘tandem’ device 32;
b) in response to a detected coupling that occurs while mobile phone 34 is ‘conducting a voice call’, tandem videophone device 32 may ‘upgrade’ the existing ‘voice-only’ call into a ‘video call’. In one example, this may be provided while maintaining a ‘connection’ with a destination party—i.e. without interrupting the call. In another example, this may be provided using some sort of ‘automatic callback’ where (i) the call is first terminated in response to the detected coupling; (ii) the tandem device puts through a ‘video call’ to the destination party immediately after (i.e. within 30 seconds) after call termination.

In some embodiments, in response to a detected decoupling that occurs during a ‘video telephone call’, mobile phone 34 may ‘downgrade’ the existing ‘video call’ call into a ‘voice-only call’. In one example, this may be provided while maintaining a ‘connection’ with a destination party—i.e. without interrupting the call. In another example, this may be provided using some sort of ‘automatic callback’ where (i) the call is first terminated in response to the detected coupling; (ii) the tandem device puts through a ‘video call’ to the destination party immediately after (i.e. within 30 seconds) after call termination.

### Power Consumption and Related Functionality

In some embodiments, a power consumption of mobile phone 34 is less than a power consumption of media playback device 30. In one example, a maximum power consumption of the mobile phone is less than 20% a maximum power consumption of the media playback device 30.

In some embodiments, a capacity of battery 154 of mobile phone 34 is less than a capacity of battery 254 of media playback device 30. The tandem videophone device 32 may be operative, in response to a detected coupling between media playback device 30 and mobile phone 34, to commence a battery recharge operation where power is transferred from video playback device 30 to mobile phone 34, and is directed to battery 154 to recharge battery 154.

### Additional Discussion of Packaging Features

The ‘mechanical packaging’ illustrated in FIGS. 1A-1D is just one example of how a first device 30 may be mechanically engaged to a second device 30 to form a ‘tandem device 32’.

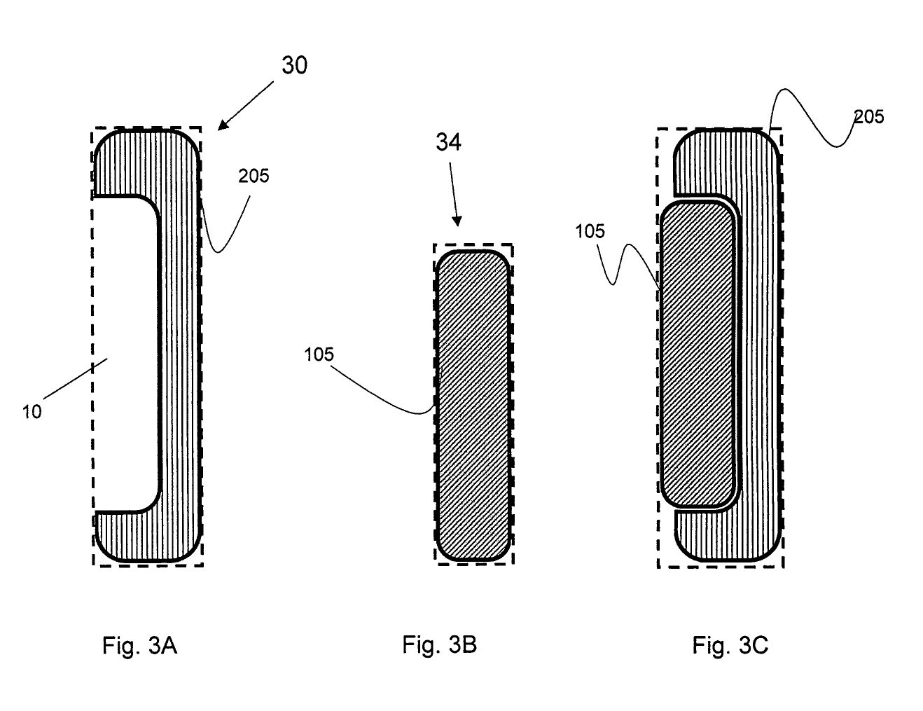

Another example is illustrated in FIGS. 3A-3C, where the housing 205 of one device 30 includes a recess 10, and the housing 105 of a second device 34 is placed within recess 10 to mechanically engage and coupled the two devices 30, 34 to each other.

In some embodiments, the recess 10 may include a locking mechanism to prevent accidental detaching and/or a sensing mechanism to determine whether or not the two units 330, 34 are in their attached or detached positions.

### A Discussion of a GPS System Including a Screenless GPS Device and a Mobile Phone

FIG. 4 is a block diagram of an exemplary ‘tandem’ global positioning service (GPS) device 332 in accordance with some embodiments of the present invention.

As illustrated in the non-limiting example of FIG. 4, screenless GPS device 330 includes a GPS module 310 for determining a device location, control circuitry 312, a speaker 348 for outputting information indicative of the device location as determined by GPS module 310, a microphone 360 for receiving user commands, a battery 354 for providing electrical power, and device port 306 for inter-device coupling. When the screenless GPS device 330 is uncoupled from mobile phone 34, the screenless GPS device 330 is operative (i) to receive voice commands via microphone 360, (ii) to generate GPS data in accordance with the received voice commands using the GPS module 310, and (iii) to present the GPS data generated according to the voice commands using the audio speaker 348.

When mobile phone 34 and screenless GPS device 330 are operatively coupled together to form a tandem device 332, tandem device 332 is operative to receive typed commands via the keypad 142 of the mobile phone 34, to generate GPS data in accordance with the received typed commands using the OPS module 310, and to present on the screen 136 of the mobile phone 34 the GPS data generated according to the typed commands.

### An Additional Discussion of Tandem Devices

The devices illustrated in FIGS. 1-4 are specific examples of tandem devices where a first device having a first independent functionality is coupled to a second device having a second independent functionality to form a “tandem device” with a ‘new’ functionality is not limited to the examples presented herein.

Exemplary ‘unit devices’ that may be coupled together to form a ‘new’ device include but are not limited to mobile phones, PDAs, MP3 players, calculators, car remote controls, smart docking stations, routers, GPSs, and so on.

In some embodiments, a device is attachable to a variety of other devices, for example, a PDA may be attached to a mobile phone or attached to an MP3 player.

In some embodiments, a packaging concept by which two “unit devices” (including but not limited to mobile phone 34 and playback device 30, or screenless GPS device 330 and mobile phone 34) may be implemented in a way that when packaged, the units are interlocked with each other by one or more of the following methods:
i) Sliding side by side, where the units (for example, 30, 34 or 330, 34) slide into each other, having an interlocking mechanism, when in the attached position.
ii) Meeting ‘face to face’: where the two units (for example, 30, 34 or 330, 34) are designed to attach when facing each other and slightly pressed against one another, having an interlocking mechanism, when in full contact with one another.
iii) Embedding male-female: where one of the units (for example, 30 or 330 or 34) is designed to contain the other unit in a niche, or recess of a hole, attracted by a magnet that holds the two units together.

Registration pins and recesses can serve to ensure accurate registration between the units. Optionally, a proximity sensor and/or a magnetic sensor, such as a Hall Effect sensor, can be used to notify one or both units that they are in the attached position.

In different embodiments, the units (30, 34 or 330, 34) that are attached or detached from one another may:
i) “Sense” when they are attached or detached; and
ii) Modify a device functionality upon sensing the attachment or detachment.

In some embodiments, a presented user interface may be changed in response to a detected coupling or decoupling. When the units (30, 34 or 330, 34) are attached, each of them may employ the screen, the battery, the keyboard, the antenna or other components of the another unit.

In some embodiments, some functions may automatically be “merged” when the units are attached, such as:
i) Charging: The unit with the larger battery can “fuel” the other device when attached.
ii) Synchronizing: The units may effect a data synchronization with each other via physical connection, such as a PDA that synchronizes its address book to a server via the mobile phone.
iii) Cross licensing: The units may share licenses that they have obtained while detached.
iv) Intercommunication: The units may communicate with one another.
v) Relay: One unit, such as a data router, serves as a communication relay for the other device.
v) Unified controlling: One or more of the controls of the units control both units.

### Concluding Remarks

It is further noted that any of the embodiments described above may further include receiving, sending or storing instructions and/or data that implement the operations described above in conjunction with the figures upon a computer readable medium. Generally speaking, a computer readable medium may include storage media or memory media such as magnetic or flash or optical media, e.g. disk or CD-ROM, volatile or non-volatile media such as RAM, ROM, etc. as well as transmission media or signals such as electrical, electromagnetic or digital signals conveyed via a communication medium such as network and/or wireless links.

Having thus described the foregoing exemplary embodiments it will be apparent to those skilled in the art that various equivalents, alterations, modifications, and improvements thereof are possible without departing from the scope and spirit of the claims as hereafter recited. In particular, different embodiments may include combinations of features other than those described herein. Accordingly, the claims are not limited to the foregoing discussion.

What is claimed is:

1) A method of operating a communications system including a mobile phone and a media playback device, the method comprising:
a) when the mobile phone is uncoupled from the media playback device, providing voice telephony services by the mobile phone using an onboard RF transceiver of the mobile phone;
b) when the media playback device is uncoupled from mobile phone, providing media playback services by the media playback device using an onboard CODEC and an onboard display screen of the media playback device; and
c) when the media playback device and the mobile phone are operatively coupled together to form a tandem device, providing video telephony services by the tandem device using the RF transceiver of the mobile phone, the CODEC of the media playback device and the display screen of the media playback device.

2) The method of claim 1 further comprising:
d) mechanically engaging the mobile phone and the media playback device via respective device ports such that a majority of a volume of the mobile phone is located within a bounding volume of the media playback device.

3) The method of claim 2 wherein the mechanical engagement is carried out such that a product of the two longest dimensions of a bounding box of the media playback device is less than twice a product of the two longest dimensions of a bounding box of the phone.

4) The method of claim 1 further comprising:
d) mechanically engaging the mobile phone and the media playback device via respective device ports to provide the operative coupling and to form the tandem device such that a volume of a bounding box of the tandem device is less than 70% times a sum of a volume of a bounding box of the mobile phone and a volume of a bounding box of the media playback device.

5) The method of claim 1 further comprising:
d) mechanically engaging the mobile phone and the media playback device via respective device ports such that the mechanical engaging blocks user access to the phone keypad of the mobile phone.

6) The method of claim 1 wherein the video telephony services are provided in accordance with user input that is received via a user control of the video playback device at a time when the media playback device is coupled to the mobile phone.

7) The method of claim 1 further comprising:
d) in response to an operative coupling between the media playback device and the mobile phone, commencing a recharging operation whereby the onboard rechargeable battery receives electrical power from the media playback device

8) A method of operating a system including a screenless GPS device and a mobile phone, the method comprising:
a) when the mobile phone is uncoupled from the screenless GPS device, providing voice telephony services by the mobile phone using a screen and a keypad of the mobile phone;
b) when the screenless GPS device is uncoupled from mobile phone, providing GPS services by:
i) receiving voice commands via a microphone of the GPS device;
ii) generating GPS data in accordance with the received voice commands using a GPS module of the GPS device; and
iii) presenting the GPS data generated according to the voice commands using the audio speaker; and
c) when the mobile phone and the screenless GPS device are operatively coupled together to form a tandem device, providing GPS services by:
i) receiving typed commands via the keypad of the mobile phone;
ii) generating GPS data in accordance with the received typed commands using the GPS module of the GPS device, and
iii) presenting on the screen of the mobile phone the GPS data generated according to the typed commands.
